(19) United States
(12) Patent Application Publication
(10) Pub. No.: US 2011/0233959 A1
(43) Pub. Date: Sep. 29, 2011

(54) FRAMELESS CONVERTIBLE TOP

(76) Inventors: Scott Cover, Fullerton, CA (US); Thor Jonsson, Studio City, CA (US)

(21) Appl. No.: 13/070,415

(22) Filed: Mar. 23, 2011

Related U.S. Application Data
(60) Provisional application No. 61/317,195, filed on Mar. 24, 2010.

(51) Int. Cl. B60J 7/00

(52) U.S. Cl. 296/107.09; 296/107.07; 296/107.01

(57) ABSTRACT

A frameless soft convertible top having a top section with a storage compartment for stowing removable side sections and a rear section of the convertible top. The convertible top has mounting straps with fasteners sewn to the top section for attaching the convertible top to body components of a vehicle and a mounting assembly for attaching to a windshield frame of the vehicle.

### CROSS-REFERENCE TO RELATED APPLICATION(S)

This application claims priority to U.S. Provisional Application No. 61/317,195 filed Mar. 24, 2010, the contents of which are incorporated herein by reference.

### FIELD OF THE INVENTION

The present invention relates generally to convertible tops, and more particularly, to a frameless multi-piece removable top, having a storage compartment.

### BACKGROUND OF THE INVENTION

There are many vehicles produced with tops that are removable, either hardtops that can be taken off, or soft, fabric tops that can be removed or retracted. Once removed, the occupants are exposed to the elements and are at risk of bad weather or adverse road conditions and may not have the removable top components available to reinstall while traveling. There are a number of products in the marketplace intended to address this issue by providing a shade over the driver, or a complete assembly that can be unfolded back into place as required. These items do not provide complete coverage and weather protection or involve complex and difficult to use assemblies to support the fabric portion of the top. Also, these current devices require space in the seating area of the vehicle to store the components when not being used. These products can be difficult to install due to the current methods used to attach the soft fabric portions to the vehicles. Consequently, a need exists for a removable soft top for a vehicle that is easy to install, remove and store.

### SUMMARY OF THE INVENTION

The present invention is a removable multi-piece soft convertible top made of vinyl or canvas material with windows on the sides and rear sections designed to be used on a vehicle without additional main support structures other than existing portions of the vehicle. Existing portions of the vehicle to which the soft top is connected include a roll bar or a cage and a windshield frame. The soft convertible top of the present invention is easily installed through the use of simple adjustable straps positioned at the rear to attach the top to the vehicle as well as a mount at the top of the windshield. The convertible top has side and rear panels that are removable leaving a center shade section over the driver compartment of the vehicle. The convertible top utilizes existing portions of a vehicle's permanent structure as support for the soft top instead of requiring a secondary convertible top structure that would need to be attached and installed in the interior of the vehicle prior to the soft top being installed. For example, the convertible soft top utilizes existing roll bar structure of common off road vehicles to hold the top above the passenger compartment, instead of using a secondary frame structure attached into the vehicle and then attaching the convertible top to the secondary frame structure.

The convertible top of the present invention is a multi-piece construction which provides panels that can be removed from the sides as well as the rear section. The panels have a window component to allow visibility out of the vehicle's sides and rear, however, the side and rear panels can be completely removed from the vehicle by utilizing zippers, snaps, Velcro or other suitable fasteners. When the sides and rear panel portions are removed, the main top panel stays in place to provide shade or protection from the outside environment. The main top section of the convertible top is constructed with two layers and a storage compartment is formed by these layers that allows the removable side and rear parts to be carried in between the layers but out of the seating area. The storage allows the components to be readily available but not in the way of the passengers. The storage compartment for the main top section is formed by attaching an outer and an inner layer around the perimeter using suitable fasteners such as Velcro or zippers. Alternatively, a soft fabric bag can be provided as an option for storage of the removed components to protect the window elements from damage. The storage bag can be constructed of soft fabric, nylon or canvas and can be utilize zippers or Velcro around the perimeter to keep the components contained and protected.

### BRIEF DESCRIPTION OF THE DRAWINGS

Other advantages of the present invention will readily appreciated, as the same becomes better understood by referencing the accompanying drawings wherein:

FIG. 1 is an exploded perspective view of the convertible top of the present invention;

FIG. 2 is an exploded perspective exploded view of the convertible top of FIG. 1 illustrating the storage compartment;

FIG. 3 is a top view of the convertible top of FIG. 2;

FIG. 4 is a detail view of a fastening hook of the convertible top of the present invention;

FIG. 5 is a side view of the convertible top of FIG. 1 as positioned on a vehicle; and

FIG. 6 is a side view of the convertible top of FIG. 5 with the side and rear panels removed.

### DETAILED DESCRIPTION

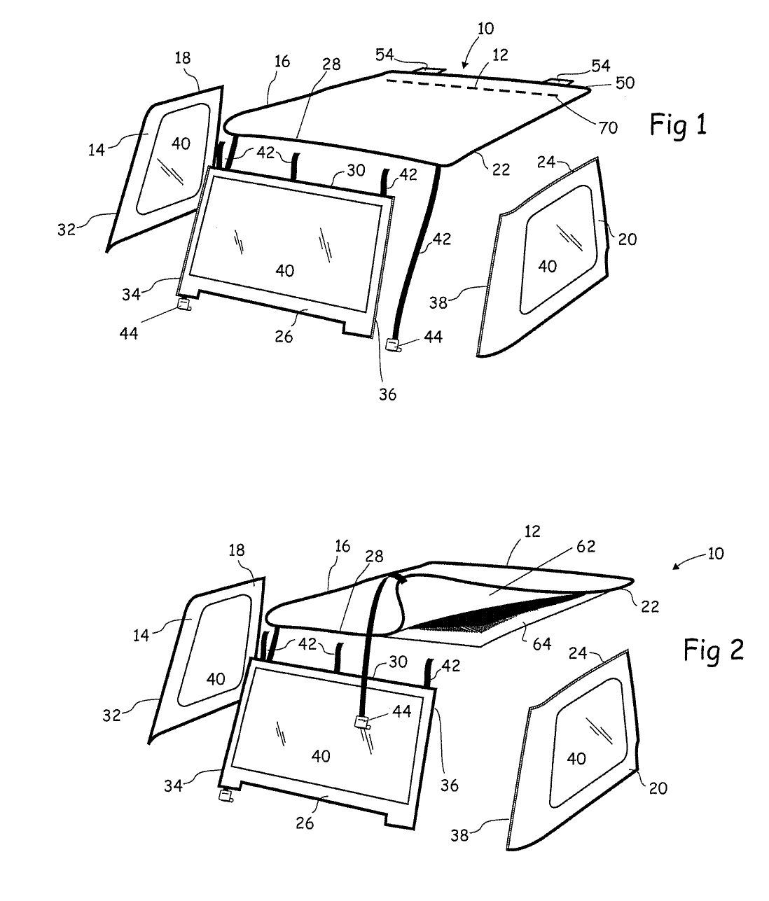

Referring to FIGS. 1 and 2, the frameless convertible top 10 of the present invention is illustrated. The frameless convertible top comprises a main or top section 12, a driver side section 14 attached to top section 12 by top edge 18 along side edge 16; a passenger side section 20 attached to the top section 12 by top edge 24 along side edge 22; and a rear section 26 attached to top portion 12 by top edge 30 along rear edge 28. Driver side section 14 is attached to rear section 26 along side edges 32, 34 of driver side section and rear section respectively. Similarly, passenger side section 20 is attached to rear section 26 along side edges 36, 38 of rear section and passenger side section respectively. All of the side edges for connecting the various sections together include fasteners for removably connecting the components and can be zippers, hook and loop fasteners, snaps, buttons, or the like. Each of the side sections and rear section have a clear window 40, typically made of a soft plastic material for ease of storage. Alternatively, the windows can be of a more rigid material such as Plexiglas or glass.

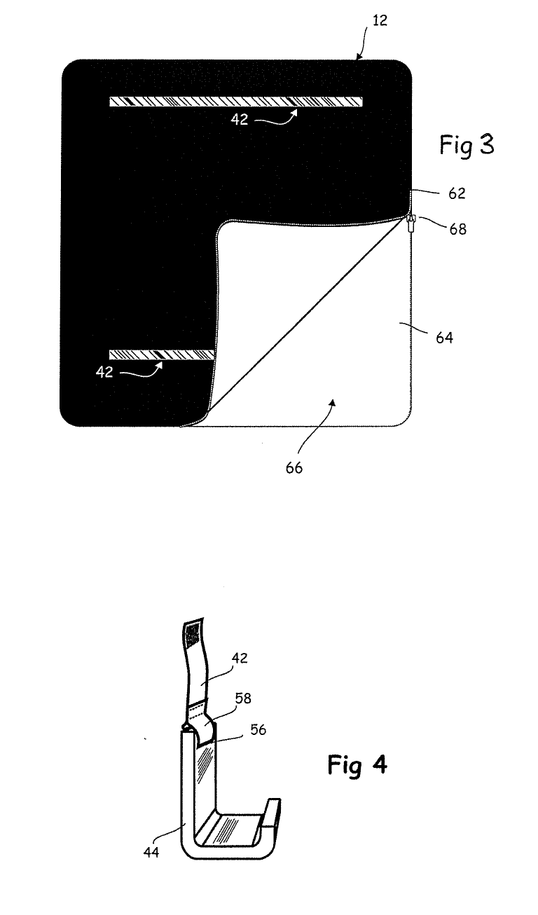

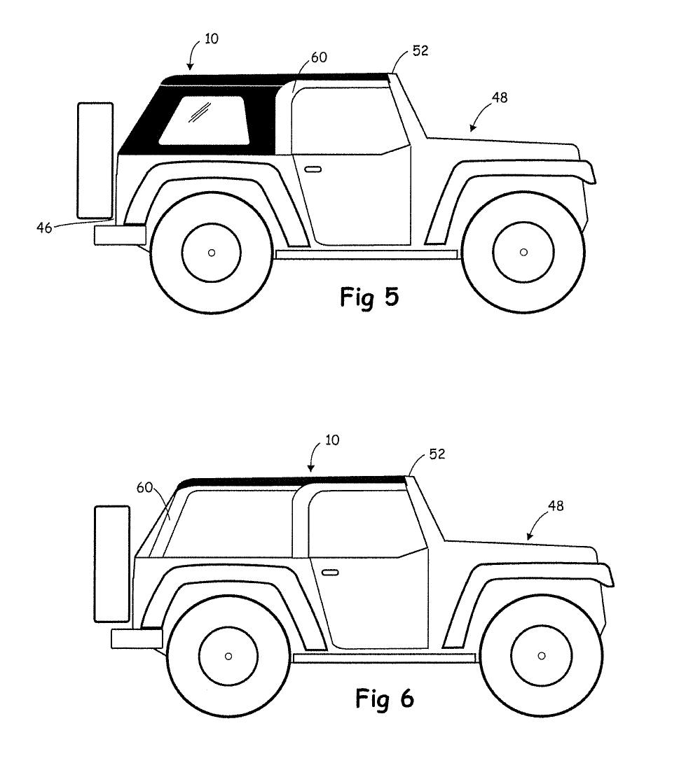

The frameless convertible top of the present invention is easily installed onto a vehicle through the use of a plurality of simple adjustable straps 42 sewn to the top section as also shown in FIG. 3 or the rear section and the adjustable straps have a hook positioned on an end of the strap for connecting to a body panel 46 of the vehicle 48 as shown in FIG. 5. The front edge 50 of the top section is attached to the windshield frame 52 by incorporating mount assemblies 54 positioned along the edge 50. As seen best in FIG. 4, the hook 44 attached to strap 42 is a J-hook having a slot 56 for threading an end 58 of the strap through which is then sewn upon itself.

The frameless convertible top uses existing portions of the vehicles permanent structure as support for the top such as the roll bar 60 as shown in FIG. 5. As previously indicated, the side and rear sections of the top are removable and can be stowed within the top section 12. Top section 12 includes an outer layer 62 and an inner layer 64 defining a storage compartment 66 therebetween as seen best in FIG. 3. A zipper 68 or other suitable fastener is positioned around the perimeter of top layer 62 and bottom layer 64 so that the layers can be fastened together and opened to access the storage compartment 66.

FIG. 5 illustrates the frameless soft top of the present invention as fully deployed upon the vehicle 48 and FIG. 6 illustrates the frameless soft top 10 having the side panels and rear panels removed and stowed within storage compartment 66. The convertible top is preferably made of a soft fabric, such as nylon or canvass and the storage compartment can be lined with additional soft fabric to protect the window elements from damage during storage. The soft plastic windows are installed into the side and rear panels by heat sealing or sewing. There may be one or more bows 70 attached into the top portion of the frameless soft top or can be a separate structure to be attached to the roll bar or other support structure on the vehicle to assists in supporting the soft top portion on the top of the vehicle and keeping it from excessive movement in use or the collection of water while stationary. Bows 70 may be constructed of rigid tube or flat materials such as fiberglass, aluminum, plastic or steel.

Although the present invention has been described and illustrated with respect to one embodiment thereof, it is to understood that changes and modifications can be made therein which are within the full intended scope of the invention as hereinafter claimed.

What is claimed is:

1. A frameless soft convertible top comprising:
a top portion having a storage compartment;
removable side portions attached along side edges of the top portion; and
a back portion removably attached along a rear of the top portion,
whereby the side portions and the back portion when removed from the top portion are positioned within the storage compartment.

2. The convertible top of claim 1 wherein the side portions and back portion each have a window.

3. The convertible top of claim 1 further comprising mounting straps extending from the top portion having a fastener for attachment of the convertible top to body components of a vehicle.

4. The convertible top of claim 1 wherein the storage compartment is a pocket located between an upper layer of the top portion and a bottom layer of the top portion.

5. The convertible top of claim 4 wherein the top layer and the bottom layer have fasteners to close the pocket.

6. The convertible top of claim 1 further comprising bows for supporting the top portion.

7. The convertible top of claim 1 wherein the top portion has a mount assembly along a front edge for attachment to a windshield frame of a vehicle.

8. A soft convertible top having a top section comprising an outer layer and an inner layer forming a cavity there between sized to stow removable side sections and a rear section.

9. The convertible top of claim 8 wherein the side sections and rear section each have a window.

10. The convertible top of claim 8 further comprising mounting straps fastened to the top section having a fastener for attachment of the convertible top to body components of a vehicle.

11. The convertible top of claim 10 wherein the fastener attached to the mounting straps is a J-hook.

12. The convertible top of claim 8 wherein the inner layer and the outer layer have fasteners positioned along the perimeter to close the cavity.

13. The convertible top of claim 8 further comprising bows positioned within the cavity of the top section.

14. The convertible top of claim 8 wherein the top section has a mount assembly along a front edge for attachment to a windshield frame of a vehicle.

15. A frameless convertible top comprising an upper panel having means for storing removable side panels and a rear panel.

16. The convertible top of claim 15 wherein the side panels and the rear panel each have a window.

17. The convertible top of claim 15 further comprising mounting straps attached to the upper panel having a fastener for attachment of the convertible top to body components of a vehicle.

18. The convertible top of claim 15 wherein the means for storing the removable side panels and rear panel is a pocket located between a top layer of the upper panel and a bottom layer of the upper panel.

19. The convertible top of claim 18 wherein the top layer and the bottom layer have fasteners to close the pocket.

20. The convertible top of claim 15 further comprising a mount assembly along a front edge of the upper panel for attachment to a windshield frame of a vehicle.
